(19) United States
(12) Patent Application Publication
(10) Pub. No.: US 2026/0307367 A1
(43) Pub. Date: Oct. 8, 2026

(54) METHOD FOR PRODUCING MULTILAYER PLASTICS STRAPS, AND MULTILAYER PLASTICS STRAP

(71) Applicant: Teufelberger Gesellschaft m.b.H., Wels (AT)

(72) Inventor: Thomas GAHLEITNER, Krenglbach (AT)

(73) Assignee: Teufelberger Gesellschaft m.b.H., Wels (AT)

(21) Appl. No.: 19/480,089

(22) PCT Filed: May 2, 2024
(86) PCT No.: PCT/AT2024/060182

§ 371 Date: Oct. 30, 2025

(30) Foreign Application Priority Data
May 3, 2023 (AT) A50331/2023

(51) Int. Cl. B32B 27/08; B29C 48/00; B29C 48/07; B29C 48/21; B29K 23/00; B29K 105/00; B29K 105/26; B29L 7/00; B32B 27/20; B32B 27/32; B65D 63/10

(52) U.S. Cl. CPC B32B 27/08; B29C 48/0022; B29C 48/07; B29C 48/21; B32B 27/20; B32B 27/32; B65D 63/10; B29C 2793/0036; B29K 2023/12; B29K 2105/0032; B29K 2105/26; B29L 2007/007; B32B 2250/02; B32B 2250/242; B32B 2305/70; B32B 2553/00

(57) ABSTRACT

A method for producing multi-layer plastic strapping bands includes providing a first and a second plastic material, melting the first and the second plastic material and joining the two plastic melts, forming a multi-layer film strand, splitting the film strand before or after a method step of drawing. The first plastic material is prepared with a content of 50 wt % to 100 wt % of exclusively mechanically recycled plastic material. The multi-layer film strand is formed such that it is made up of 50 wt % to 95 wt % of the first plastic material and 5 wt % to 50 wt % of the second plastic material. The multi-layer plastic strapping band is made up of a base layer from the first plastic material and surface layers from a second plastic material that are connected to a top side and to a bottom side of this base layer.

The invention relates to a method for producing multi-layer plastic strapping bands, and a multi-layer plastic strapping band.

Plastic strapping bands are used predominantly for securing goods and/or for the secured fixing of goods. To this end, these strapping bands are wrapped around the goods to be secured and the strapping bands are tensioned, and the ends of the bands are generally interconnected, for example by welding. Strapping bands from plastic have numerous advantages over strapping bands from other materials, such as steel. For example, plastic strapping bands are simpler and lower-cost to produce, simpler to handle, corrosion-free and also have a lower CO₂ footprint. Such strapping bands and/or their application purpose and their properties are generally specified in EN 13394, for example, and/or in national standards corresponding to this European standard, such as ÖNORM EN 13394, for example.

Thermoplastic plastics are used to produce plastic strapping bands. The high tensile strengths required for the purpose of use are provided to the plastic strapping bands by mono-axial drawing by means of so-called stretching units. Such drawing ensures that an orientation of the macromolecule chains in a stretching direction and/or longitudinal direction is induced in the plastic strapping bands, whereby the high tensile strengths of the plastic materials in this direction are achieved. Especially in semi-crystalline, thermoplastic plastic materials, this achieves similarly high tensile strengths as in steel, for example.

The methods for producing and using plastic strapping bands have generally long been known. An abstract of such methods is provided in DE 40 07 560 A1, for example. Here, more recent approaches are often targeted either at an improvement of the properties in the actual strapping operation, such as an improved handling during the (machine) wrapping, improved connectability and/or weldability and suchlike.

Another aspect relates to the production costs, and in particular the material costs. In accordance with common practice, high-quality plastic materials are used, as the required, high tensile strengths and tear resistance of the strapping bands require good properties of the plastic materials, such as sufficiently high mean molecular weights and molecular weight distributions. For this reason, like-new plastic materials are often used to produce the plastic strapping bands.

But also the use of recycled plastic material is generally known. Recycled materials are indeed used, for example, in strapping bands from polycondensates, in particular in polyester strapping bands, wherein these recycled polycondensates are often subjected to a chemical solid- or liquid-phase polycondensation, often under negative pressure and/or vacuum, as part of the recycling process before being processed into strapping bands. Such an upstream polycondensation enables the molecular weight and/or the so-called intrinsic viscosity (IV) of the polycondensates to be increased, wherefore such recycled polycondensate plastic material has excellent properties. As known, the properties of polycondensates thus recycled may even exceed those of freshly polymerized polycondensates.

Also multi-layer plastic strapping bands and their production have been described, for example in DE 28 16 044 A1 and EP 2 954 999 A1. DE 28 16 044 A1 discloses multi-layer bands with a base layer and at least one surface layer connected to the base layer, wherein the polymer of the surface layer is to have a higher structural viscosity and/or a higher molecular weight than the polymer of the base layer. EP 2 954 999 A1 teaches in particular the use of expensive polyester in a core layer, wherein the core layer is sheathed by so-called functional layers, in which functional layers also plastic material that may not be polyester and would therefore be lower-cost can be used. Here, these functional layers may also comprise additives, by means of which additives specific functional properties are to be achievable.

Also in light of the existing prior art, there is a need for further improvement with respect to a production of plastic strapping bands and/or corresponding plastic strapping bands that is as sustainable and cost-efficient as possible.

It was an object of the present invention to overcome the still existing deficits of the prior art and make available a plastic strapping band that can be produced in a sustainable and cost-efficient manner while having the required mechanical properties for use as strapping, and provision a corresponding method for producing such a plastic strapping band.

This object is achieved by a method for producing a multi-layer plastic strapping band, and a multi-layer plastic strapping band in accordance with the claims.

The method for producing multi-layer plastic strapping bands comprises:
provisioning a first plastic material consisting of 70 wt % to 100 wt % of a thermoplastic, first polymer and 0 wt % to 30 wt % of another component or multiple other components, and provisioning a second plastic material consisting of 90 wt % to 100 wt % of a second, semi-crystalline, thermoplastic polymer and 0 wt % to 10 wt % of another component or multiple other components,
melting the first plastic material by means of an extrusion device while forming a first plastic melt and melting the second plastic material by means of another extrusion device while forming a second plastic melt,
joining the first plastic melt and the second plastic melt, such that the second plastic melt covers completely a top side and a bottom side of the first plastic melt,
forming a multi-layer film strand by feeding the first plastic melt and the second plastic melt to a forming device in a material transport direction, and cooling down the first plastic material and the second plastic material, so that a base strand layer and a surface strand layer connected to a top side of this base strand layer and a surface strand layer connected to a bottom side of this base strand layer of the multi-layer film strand are formed,
splitting and/or cutting the multi-layer film strand into multi-layer band strands along the material transport direction by means of splitting devices,
drawing the multi-layer film strand or the multi-layer band strands in the material transport direction by means of a stretching device.

Here, the first plastic material is provisioned with a content of 50 wt % to 100 wt % of exclusively mechanically recycled plastic material. The multi-layer film strand is formed such that it consists of 50 wt % to 95 wt % of the first plastic material and 5 wt % to 50 wt % of the second plastic material.

It should be noted in this context that, even if the method in accordance with the invention is specified in a specific order, this order is not mandatory and the sequence of the individual method steps may be switched, to the extent that this is technically useful and possible. For example, the method step of the splitting of the multi-layer film strand may be performed before or also after the drawing of the multi-layer film strand. Also, the execution of intermediate steps, even intermediate steps not explicitly described here, between the individual, specified method steps is possible and not excluded. Of course, some of the method steps must be executed in a specific order for technical reasons and/or also due to the definitions of features in the claims. For example, the melting of the first and of the second plastic material must be carried out before the forming of the multi-layer film strand, of course. The material transport direction mentioned may, as generally known, also be referred to as and/or is synonymous with the machine direction (MD).

The method may in particular be provided for producing multi-layer plastic strapping bands as specified in (ÖNORM) EN 13394 and/or in accordance with (ÖNORM) EN 13394. The method may therefore be provided for producing multi-layer plastic strapping bands with a tensile strength of at least 300 N/mm².

In particular a plastic material consisting of 70 wt % to 98 wt % thermoplastic, first polymer and 2 wt % to 30 wt % of another component or multiple other components may be provisioned as the first plastic material. Independent of the amount of the other component or of the other components of the first plastic material, this or these other component(s) of the first plastic material may be formed by fillers, additives, plasticizers or also by one or more other polymer(s) than the first polymer, for example.

In this context, a plastic material with a content of foreign polymer, i.e. a different polymer than the first, thermoplastic polymer, for example, may be provisioned as the first plastic material. For example, a content of foreign polymer may be from 2 wt % to 30 wt %. Here, the foreign polymer may absolutely comprise a layer-forming gas- or liquid-barrier plastic, and/or a copolymer. Yet, also a plastic material with a content of inorganic fillers, for example a content of inorganic fillers from 2 wt % to 30 wt %, in particular 5 wt % to 30 wt %, may be provisioned as the first plastic material. The inorganic filler may be formed by chalk, talc or a mixture thereof, for example. Independent thereof or in addition, a plastic material comprising solid particles with a particle size of up to 500 μm, in particular 150 μm to 500 μm, may be provisioned as the first plastic material. Accordingly, the first plastic material may be filtered and/or may have been filtered by a filtering device with a mesh size of 500 μm as part of the melting, or as part of a melting operation performed upstream of the present method. Also a plastic material comprising colorants, such as printing inks, for example in a content of 2 wt % to 30 wt %, may be provisioned as the first plastic material. Preferably, a post-consumer-recycling (PCR) plastic material may be provisioned as the first plastic material. Also a plastic material comprising components that are non-melting at a melting and/or processing temperature as part of the melting of the first plastic material may be provisioned as the first plastic material.

In addition to the exclusively mechanically recycled plastic material, the first plastic material may also comprise up to 50 wt % non-recycled or chemically recycled plastic material. Preferably, the first plastic material may be provisioned with a content of 80 wt % to 100 wt % of exclusively mechanically recycled plastic material and additionally up to 20 wt % non-recycled or chemically recycled plastic material. Independent of the type of production and/or preparation and/or the type of provisioning of the components for the first plastic material and as specified in the claims, the first plastic material consists of 70 wt % to 100 wt % of the thermoplastic, first polymer and 0 wt % to 30 wt % of the other component or the multiple other components. The thermoplastic, first polymer may be formed by polyethylene terephthalate, polypropylene, polyethylene, polyamide or polystyrene, for example. In particular, a plastic material that consists entirely of exclusively mechanically recycled plastic material may be provisioned as the first plastic material.

A non-recycled or chemically recycled plastic material, or also a high-quality, mechanically recycled plastic material, in particular a mechanically recycled post-industrial-recycling plastic material, may be provisioned as the second plastic material. It holds true also for the second plastic material that, independent of the amount of the other component or of the other components of the second plastic material, this or these other component(s) of the second plastic material may be formed by fillers, additives, plasticizers or also by one or more other polymer(s) than the second, semi-crystalline polymer, for example.

In contrast to the first plastic material, a plastic material that does not comprise any printing inks, layer-forming gas- or liquid-barrier plastics and additionally components that are non-melting at a melting and/or processing temperature as part of the melting of the second plastic material, such as metals, wood fillers, glass (fibers) or also polymers melting at a higher temperature than the melting and/or processing temperature, may be provisioned as the second plastic material. Furthermore, a plastic material comprising a maximum content of 10 wt %, preferably a maximum of 5 wt % of inorganic filler, such as chalk or talc, or also colorants for dyeing plastic materials, for example, such as master batch dyes, may be provisioned as the second plastic material. A plastic material comprising solid particles with a particle size of up to 150 μm may be provisioned as the second plastic material. Accordingly, the second plastic material may be filtered and/or may have been filtered by a filtering device with a mesh size of 150 μm as part of the melting, or as part of a melting operation performed upstream of the present method.

An exclusively mechanically recycled plastic material is understood to mean a plastic material already utilized and/or used at least once in which no chemical recycling, in particular no chemical reaction, was carried out in a targeted manner as part of the recycling. As known, a chemical recycling may be performed by chain splitting and/or depolymerization of polymers through to monomers and subsequent repolymerization. In particular, the first plastic material may be a post-consumer and/or post-industrial article and/or plastic material.

A chemically recycled plastic material is accordingly understood to mean a plastic material in which such very chemical reactions were induced in a targeted manner, in particular a depolymerization and subsequent repolymerization were carried out, as part of the recycling. A non-recycled plastic material is understood to mean a freshly polymerized and/or produced plastic material that has not yet been utilized, i.e. a like-new plastic material and/or new plastic material.

The cooling down of the multi-layer film strand may be performed exclusively by means of the forming device itself. To this end, the first and the second plastic melt, after having been joined, may be cooled down, for example by means of at least one temperature-controllable roll and/or roll with a temperature-controllable roll surface of the forming device. For example, a cooling agent may be able to be applied to at least one roll of the forming device. In addition, also a separate cooling down of the plastic melts before the forming of the multi-layer film strand and/or an additional, separate cooling down of the film strand after forming the film strand may be performed by means of an additional cool-down device, such as a water bath. A film thickness of the multi-layer film strand may be adjusted in a targeted manner, for example, as generally known, by guiding the joined plastic melts through a gap between adjacent rolls of the forming device, wherein at least one of the adjacent rolls may be arranged so as to be adjustable for modifying the film thickness. As generally known, the forming device may be formed by a rolling mill, also referred to as a calender and/or smoothing calender.

The splitting of the multi-layer film strand may be carried out by means of splitting devices configured as knife blades, circular blades that are non-rotatable or rotatable along or opposite the material transport direction, or also by means of splitting devices configured as a laser or water beam, for example. As mentioned above, this splitting of the film strand may generally be performed before or after the drawing.

A thickness of the multi-layer film strand after the forming may be adjusted to 0.6 mm to 3.8 mm, preferably 0.8 mm to 2.8 mm, for example. The drawing ensures that a thickness of the multi-layer band strands and/or optionally a thickness of the multi-layer film strand can be adjusted to and/or respectively reduced to a value of 0.15 mm to 1.8 mm, preferably of 0.2 mm to 1.4 mm. A width of the multi-layer band strands after the drawing and splitting may be adjusted to a value of 3 mm to 40 mm, in particular 4 mm to 36 mm, wherein the width of the drawn, multi-layer band strands may be selected predominantly according to the respectively intended purpose of use for the multi-layer plastic strapping bands.

The production method specified ensures that plastic strapping bands can be produced in a more sustainable and also more cost-efficient manner than before. This is in particular enabled by using a large amount of exclusively mechanically recycled plastic material, which can be produced and/or provisioned in a low-cost and sustainable manner, for forming the first plastic material and/or for forming the base strand layer.

Surprisingly, it has turned out that such exclusively mechanically recycled plastic material can be processed sufficiently easily into multi-layer plastic strapping bands and that the plastic strapping bands produced according to the method also have sufficiently good properties for use as strapping bands. Without wanting to be bound by a theory, it is assumed that the surface layers from the second plastic material that are connected to the base strand layer are able to sufficiently stabilize the entire layer structure in particular as part of the mechanically extremely straining and thus process-critical step of the drawing. Surprisingly, the relatively low amount of second plastic material of 5 wt % to 50 wt % is more than sufficient for this purpose. Preferably, the multi-layer film strand may be formed such that it consists of 55 wt % to 90 wt % of the first plastic material and 10 wt % to 45 wt % of the second plastic material.

Here, the first plastic material and/or the base strand layer may also absolutely contain considerable amounts of component(s) that are not thermoplastic polymer. For example, it has turned out that also plastic materials having a high filler content of up to 30 wt % and therefore being considered as not actually materially recyclable, can be processed into multi-layer plastic strapping bands with the specified method, i.e. can indeed be materially recycled and/or reused. Here, the first plastic material may even contain regrind or agglomerates or even be formed by regrind, for example. In particular, it has turned out that the drawing operation and/or drawing step can absolutely be achieved, at least in combination with the stabilizing effect of the surface layer connected to the base strand layer. Here, entirely customary drawing ratios of 1:4 to 1:20 can be used for the method step of the drawing.

Subsequently to the method step of the drawing, other method steps may optionally be carried out. For example, as generally known, a drawn band strand may yet be embossed, waxed, imprinted or treated otherwise. Subsequently, the multi-layer band strands may be custom packaged, of course. Usually, the resulting band strands are wound up on spools as so-called endless strands for custom packaging and are cut into ready-to-use strapping bands with a respectively suitable and/or required band length only at the place of use.

In an advancement of the method, it may be provided that a plastic material with a melt mass flow rate (MFR) according to ISO 1133 of 2 g/10 min to 35 g/10 min is provisioned as the first plastic material, and that a plastic material with a melt mass flow rate (MFR) according to ISO 1133 that is equal or greater in comparison to the first plastic material is provisioned as the second plastic material.

This execution of the method enables in particular a process-reliable forming of the multi-layer film strand with a homogeneous and even and/or uniform formation of the layers. In particular, irregularities in the layer formation can be impeded.

Generally, the first, thermoplastic polymer and the second, semi-crystalline, thermoplastic polymer may respectively be formed by any polymers.

Preferably, it may be provided in the method, however, that plastic materials of the same type are provisioned as the first plastic material and as the second plastic material.

This measure enables in particular the production of a film strand with a stable and permanently even layer structure and improved mutual adhesion of the base strand layer and the surface strand layers. Plastic materials of the same type are understood to mean plastic materials comprising the same type of thermoplastic polymer. For example, in this embodiment variant, both the first and the second plastic material may comprise as thermoplastic polymers respectively a polyolefin, respectively a polyester or respectively a polyamide as the first and/or second polymer, for example.

In particular, it may be provided that plastic materials in which a chemical molecular formula of the thermoplastic, first polymer corresponds to a chemical molecular formula of the semi-crystalline, thermoplastic, second polymer, are provisioned as the first plastic material and as the second plastic material.

This execution of the method enables in particular the adhesion of the surface strand layers to the base strand layer to be further improved again as part of the formation of the multi-layer film strand and also during the drawing, but also subsequently when using the multi-layer plastic strapping bands.

An embodiment of the method may be particularly expedient in which plastic materials in which both the thermoplastic, first polymer and the semi-crystalline, thermoplastic, second polymer are formed by polypropylene are provisioned as the first plastic material and as the second plastic material.

Specifically plastic materials based on polypropylene have proven particularly suitable for forming the multi-layer plastic strapping bands.

In the method, a plastic material with a content of 2 wt % to 30 wt % of fillers, for example, may be provisioned as the first plastic material.

This ensures that in particular the production costs of the multi-layer plastic strapping bands can be reduced, as the provisioning of a plastic material with a high content of filler(s) is generally lower in cost.

In particular, a plastic material with a content of 2 wt % to 30 wt % of coloring filler(s) may be provisioned as the first plastic material.

Such fillers may be contained in the first plastic material as particularly low-cost materials.

Nevertheless, in particular the multi-layer, drawn band strands, for example, may be imprinted on a surface strand layer or on the surface strand layers after the drawing, as a surface strand layer may be effective as a cover layer in relation to a base strand layer connected to the surface strand layer and a coloring of the base layer can thus be easily covered.

In a particularly preferred embodiment of the method, it may be provided that the multi-layer film strand is split into multi-layer band strands by means of the splitting devices after the forming and before the drawing.

The splitting of the multi-layer film strand before the drawing enables the cutting and/or slitting operation to be carried out very gently and with very low wear and little abrasion. This is possible since the film strand still has a high temperature and is still relatively soft at this time of the method. Here, this relatively high temperature is actually necessary for the subsequent drawing step. In this context, it has turned out, however, that, despite the still soft consistency of the film strand, a highly precise splitting of the multi-layer film strand is possible by means of conventional splitting and/or cutting devices, and that there are hardly any deviations in the respective band strand widths of the split, undrawn band strands. Furthermore, such an execution of the method enables multi-layer, drawn band strands with highly uniform band strand widths and band strand thicknesses even after the drawing to be formed. This is possible despite the considerable deforming that inherently accompanies the drawing following the splitting of the multi-layer, split band strands. A splitting before the step of the drawing is specifically advantageous when forming multi-layer film and/or band strands, as, in contrast to a splitting after the drawing, delamination tendencies can be impeded.

It has further proven advantageous during the splitting of the film strand before the drawing if the multi-layer film strand is cooled down to a temperature of 75° C. to 135° C. for the method step of the splitting.

Below the specified temperature range, there may already be an increased wear of the splitting devices, in particular in splitting devices in the form of cutting tools, in some plastic materials. Above the specified temperature range, for example due to an increased material flow of the plastic material, the multi-layer, undrawn band strands may stick together again, and multi-layer, undrawn band strands with inhomogeneous band strand widths and band strand thicknesses may be formed, in particular in the peripheries of the multi-layer band strands. In particular, the multi-layer film strand may be cooled down to a temperature of 80° C. to 130° C. for the method step of the splitting.

Furthermore, it may be provided in the method that the forming of the multi-layer film strand is carried out by means of a forming device comprising rotatably-mounted rolls. In particular, the forming device may be formed by a so-called rolling mill, also referred to as a calender and/or smoothing calender. As mentioned above, the forming of the film strand may be performed by means of such rolls, wherein a film thickness of the multi-layer film strand may be adjusted in a targeted manner, for example by guiding the first plastic melt through a gap between adjacent rolls. Here, at least one of the adjacent rolls may be arranged so as to be adjustable for modifying the film thickness. In the present method, forming devices comprising rolls have proven particularly well-suited for forming film strands with a highly uniform and even structure and very evenly designed surfaces of the top and bottom sides.

In this context, it may also be expedient if at least one surface of the multi-layer film strand is structured by means of at least one structured roll surface as part of the method step of the forming of the film strand. Such a surface structure on at least one surface may be useful in particular when using the plastic strapping bands for forming a strapping. For example, such a surface structure can support and/or facilitate the commonly performed welding. In particular, such a surface structure can make a so-called friction welding operation considerably easier and/or more efficient. For example, the at least one surface of the multi-layer film strand may be provided with a microstructure, in particular with a microstructure in the sense of a matting, which microstructure is not detectable by the naked eye. Of course, a generally known embossing that is detectable by the naked eye, for example a conventional embossed lozenge pattern, is also possible. Alternatively, it may also be of advantage for specific applications, however, if the surfaces of the multi-layer film strand are designed so as to be very smooth, i.e. are smoothed by means of at least one roll surface.

If a splitting of the multi-layer film strand is carried out before the drawing, it may further be provided that at least some of the splitting devices are adjusted along the direction extending parallel to the band strand widths for adjusting band strand widths of the multi-layer, undrawn band strands. Such an execution of the method allows for a simple but efficient adjusting of respectively desired band strand widths of the multi-layer, undrawn band strands, and, in combination with the subsequent drawing, therefore also a targeted adjusting of respectively desired band strand widths of the multi-layer, drawn band strands and/or of the ultimately resulting plastic strapping bands. In particular, all existing splitting devices may be adjusted along the direction extending parallel to the band strand widths for adjusting the band strand widths of the multi-layer, undrawn band strands. In addition, in the context of the adjusting along the band strand widths, it may also be provided, however, that at least some of the splitting devices are adjusted away from the multi-layer film strand or the multi-layer, undrawn band strands.

It may further also be useful in the context of the adjusting of the splitting devices that actual values of the band strand widths of the multi-layer, drawn band strands are detected by means of at least one sensor device subsequently to the drawing, and the splitting devices are adjusted along the direction extending parallel to the band strand widths with respect to respectively desired target values for the band strand widths of the multi-layer, drawn band strands on the basis of these determined actual values for adjusting the band strand widths of the multi-layer, undrawn band strands. This measure allows for a simple and variable adjusting of respectively desired band strand widths for the undrawn and also the drawn band strands and thus provisions a particularly flexible execution of the method. The at least one sensor device may in particular be formed by an optical sensor, in particular a camera.

To automate the adjusting of the splitting devices along the direction of the band strand widths, it may be expedient here if the detected actual values of the band strand widths of the multi-layer, drawn band strands are transmitted to a control device by the sensor device and the splitting devices are adjusted along the direction extending parallel to the band strand widths through automated control by the control device for adjusting the band strand widths of the multi-layer, undrawn band strands. This enables in particular a high level of automation of the method.

Yet, independent of this, a method variant may also be advantageous in which, subsequently to the drawing, actual values of the band strand thicknesses of the multi-layer, drawn band strands are detected by means of at least one sensor device and that a film strand thickness of the multi-layer film strand is adjusted with respect to respectively desired target values for the band strand thicknesses of the multi-layer, drawn band strands by means of the forming device. This measure allows in particular a simple and variable adjusting of respectively desired band strand thicknesses of the multi-layer, drawn band strands. The at least one sensor device may be formed by an optical sensor again, in particular a camera. Here, basically the same sensor device may be used that is also used for determining the band strand widths of the drawn band strands, or also a separate sensor device, of course.

Also in relation to the determining of the band strand thicknesses of the multi-layer, drawn band strands, it may be provided again that the detected actual values of the band strand thicknesses of these drawn band strands are transmitted to a control device by the sensor device and the film strand thickness is adjusted through automated control of the forming device by means of the control device. Also this measure allows for a highly automated execution of the method.

The object of the invention, however, is also achieved by a multi-layer plastic strapping band. The plastic strapping band may in particular be produced according to the and/or with the method described above.

The multi-layer plastic strapping band consists of a base layer from a first plastic material and surface layers from a second plastic material, which surface layers are connected to a top side and to a bottom side of this base layer. Here, the first plastic material is formed by 70 wt % to 100 wt % thermoplastic, first polymer and 0 wt % to 30 wt % of another component or multiple other components. The second plastic material is formed by 90 wt % to 100 wt % semi-crystalline, thermoplastic, second polymer and 0 wt % to 10 wt % of another component or multiple other components. Furthermore, the first plastic material has a content of 50 wt % to 100 wt % of exclusively mechanically recycled plastic material. The multi-layer plastic strapping band consists of 50 wt % to 95 wt % of the first plastic material and of 5 wt % to 50 wt % of the second plastic material.

The multi-layer plastic strapping band may be a strapping band as specified in (ÖNORM) EN 13394 and/or be configured in accordance with (ÖNORM) EN 13394. The multi-layer plastic strapping band may have a tensile strength of at least 300 N/mm².

The first plastic material may in particular be formed by a plastic material consisting of 70 wt % to 98 wt % thermoplastic, first polymer and 2 wt % to 30 wt % of another component or multiple other components. Independent of the amount of the other component or the other components of the first plastic material, this or these other component(s) may be formed by fillers, additives, plasticizers or also by one or more other polymer(s) than the first polymer, for example.

The first plastic material may comprise, in this context, a content of foreign polymer, for example, i.e. a different polymer than the first, thermoplastic polymer. For example, a content of foreign polymer may be from 2 wt % to 30 wt %. Here, the foreign polymer may absolutely comprise a layer-forming gas- or liquid-barrier plastic, and/or a copolymer. Yet, the first plastic material may also comprise a content of inorganic fillers, for example a content of inorganic fillers from 2 wt % to 30 wt %, in particular 5 wt % to 30 wt %. Here, the inorganic filler may be formed by chalk, talc or a mixture thereof, for example. Independent thereof or in addition, the first plastic material may comprise solid particles with a particle size of up to 500 μm, in particular 150 μm to 500 μm. The first plastic material may also comprise colorants, such as printing inks, for example in a content of 2 wt % to 30 wt %. Preferably, the first plastic material may be a post-consumer-recycling (PCR) plastic material.

In addition to the exclusively mechanically recycled plastic material, the first plastic material may also have up to 50 wt % non-recycled or chemically recycled plastic material. Preferably, the first plastic material may consist of a content of 80 wt % to 100 wt % of exclusively mechanically recycled plastic material and additionally up to 20 wt % non-recycled or chemically recycled plastic material. Independent of the origin and/or preparation and as specified in the claims, the first plastic material consists of 70 wt % to 100 wt % of the thermoplastic, first polymer and 0 wt % to 30 wt % of the other component or the multiple other components. The thermoplastic, first polymer may be formed by polyethylene terephthalate, polypropylene, polyethylene, polyamide or polystyrene, for example. In particular, the first plastic material may consist entirely of exclusively mechanically recycled plastic material.

The second plastic material may be formed by a non-recycled or chemically recycled plastic material, or also a high-quality, mechanically recycled plastic material, in particular by a mechanically recycled post-industrial-recycling plastic material. It holds true also for the second plastic material that, independent of the amount of the other component or of the other components of the second plastic material, this or these other component(s) may be formed by fillers, additives, plasticizers or also by one or more other polymer(s) than the second, semi-crystalline polymers, for example.

Unlike the first plastic material, the second plastic material may comprise no printing inks, no layer-forming gas- or liquid-barrier plastic and also no high-melting-point or non-melting components, such as metals, wood fillers, glass (fibers) or also polymers melting at a high temperature. Furthermore, the second a plastic material may comprise a maximum content of 10 wt %, preferably a maximum of 5 wt % of inorganic filler, such as chalk or talc, or also colorants for dyeing plastic materials, for example, such as master batch dyes. The second plastic material may comprise solid particles with a particle size of up to 150 μm.

An exclusively mechanically recycled plastic material is understood to mean a plastic material already utilized and/or used at least once in which no chemical recycling, in particular no chemical reaction, was carried out in a targeted manner as part of the recycling. As known, a chemical recycling may be performed by chain splitting and/or depolymerization of polymers through to monomers and subsequent repolymerization. In particular, the first plastic material may be a post-consumer and/or post-industrial article and/or plastic material.

A chemically recycled plastic material is accordingly understood to mean a plastic material in which such very chemical reactions were induced in a targeted manner, in particular a depolymerization and subsequent repolymerization were carried out, as part of the recycling. A non-recycled plastic material is understood to mean a freshly polymerized and/or produced plastic material that has not yet been utilized, i.e. a like-new plastic material and/or new plastic material.

Preferably, the multi-layer plastic strapping band may consist of 55 wt % to 90 wt % of the first plastic material and 10 wt % to 45 wt % of the second plastic material.

A thickness of the multi-layer plastic strapping band may be 0.15 mm to 1.8 mm, preferably from 0.2 mm to 1.4 mm. A width of the multi-layer plastic strapping band may be 3 mm to 40 mm, in particular 4 mm to 36 mm. The surface layer(s) may be surface treated and may be embossed, for example.

Such a multi-layer plastic strapping band with the specified composition can be produced more sustainably and also more cost-efficiently than before. This is in particular enabled by using a large amount of exclusively mechanically recycled plastic material that can be produced and/or provisioned in a low-cost and sustainable manner for forming the first plastic material. Surprisingly, it turned out that such plastic strapping bands have sufficiently good properties for use as strapping bands.

Here, the first plastic material and/or the base layer may also absolutely contain considerable amounts of components that are not thermoplastic polymer. For example, it has turned out that also plastic materials having a high filler content of up to 30 wt % and are therefore not actually considered materially recyclable, may be contained.

Generally, the first, thermoplastic polymer and the second, semi-crystalline, thermoplastic polymer may respectively be formed by any polymers.

Yet, preferably, in this context, it may be provided that the first plastic material and the second plastic material are formed by plastic materials of the same type.

Plastic materials of the same type are understood to mean plastic materials comprising the same type of thermoplastic polymer. For example, in this embodiment variant, both the first and the second plastic material may comprise as thermoplastic polymers respectively a polyolefin, respectively a polyester or respectively a polyamide as the first and/or second polymer, for example. Plastic strapping bands thus configured have an improved mutual adhesion of the base layer and surface layers.

In particular, a design of the plastic strapping band may be advantageous in which the first plastic material and the second plastic material are formed by plastic materials in which a chemical molecular formula of the thermoplastic, first polymer corresponds to a chemical molecular formula of the semi-crystalline, thermoplastic, second polymer.

This design of the multi-layer plastic strapping band enables the adhesion of the surface layers and of the base layer to be further improved again.

In particular, it may be provided in the plastic strapping band that the first plastic material and the second plastic material are formed by plastic materials in which both the thermoplastic, first polymer and the semi-crystalline, thermoplastic, second polymer are formed by polypropylene.

Specifically plastic materials based on polypropylene have proven particularly suitable for forming the multi-layer plastic strapping bands.

It may furthermore be provided in the multi-layer plastic strapping band that the first plastic material is formed by a plastic material with a content of 2 wt % to 30 wt % of filler(s).

This ensures that in particular the production costs of the multi-layer plastic strapping band can be reduced, as the provisioning of a plastic material with a high content of filler(s) is generally lower in cost.

Furthermore, it may be provided in the multi-layer plastic strapping band that the first plastic material is formed by a plastic material with a content of 2 wt % to 30 wt % of coloring filler(s).

Such fillers may be contained in the first plastic material as particularly low-cost materials. Nevertheless, the multi-layer plastic strapping band may be imprinted on at least one of the surface layers, since a surface layer may be effective as a cover layer in relation to a base strand layer connected to the surface layer and a coloring of the base layer can thus be easily covered.

For the purpose of better understanding of the invention, it will be elucidated in more detail by means of the figures below.

The figures show in a respectively very simplified schematic representation:

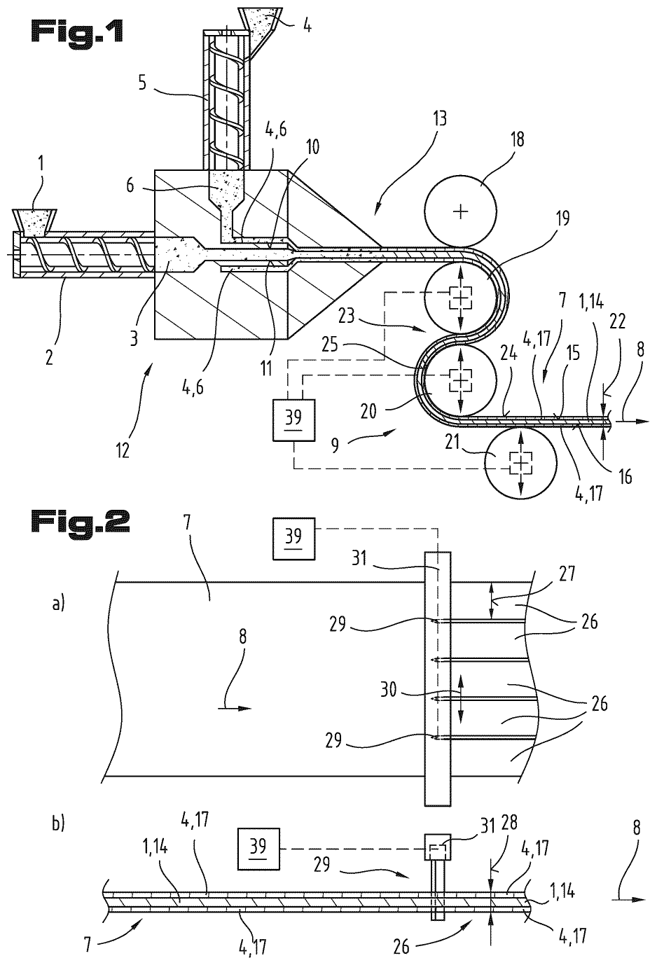

FIG. 1 an exemplary embodiment of method steps melting plastic materials, joining plastic melts and forming a multi-layer film strand, in a lateral view;

FIG. 2 an exemplary embodiment of a method step splitting a multi-layer film strand, in a lateral view and in a top view from above;

FIG. 3 an exemplary embodiment of a method step drawing multi-layer band strands in a lateral view and in a top view from above;

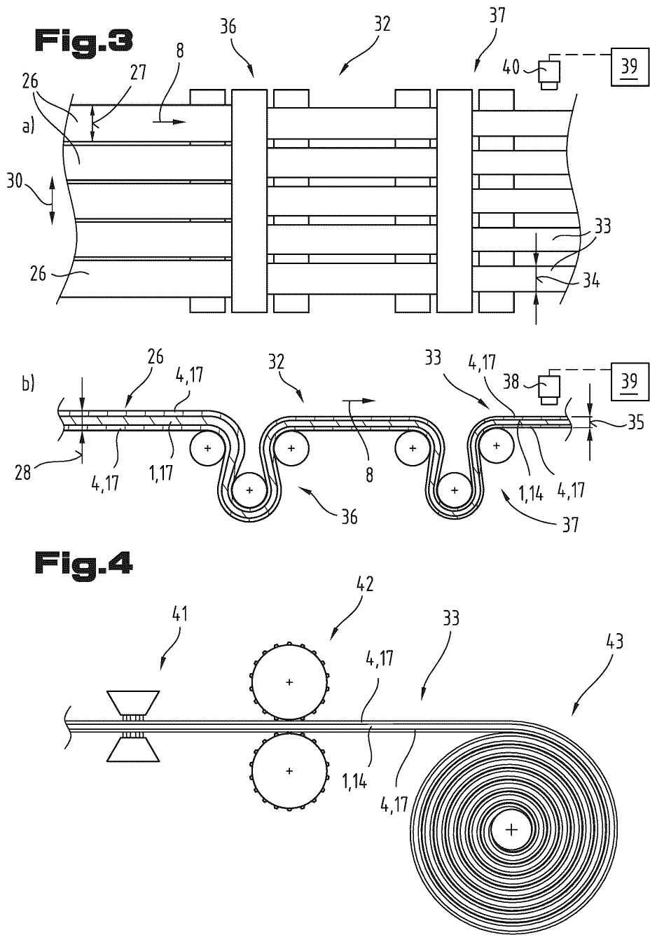

FIG. 4 an exemplary embodiment of other method steps after the drawing of multi-layer band strands, in a lateral view;

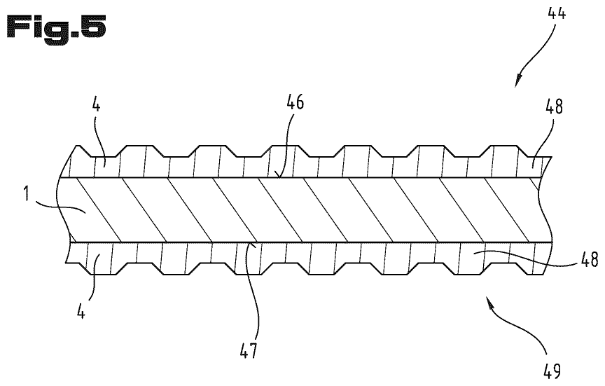

FIG. 5 an exemplary embodiment of a multi-layer plastic strapping band, in a sectional view.

First of all, it is to be noted that, in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure, and in case of a change of position, these specifications of location are to be analogously transferred to the new position.

The present method for producing multi-layer plastic strapping bands may in particular be provided for producing strapping bands as specified in (ÖNORM) EN 13394. Accordingly, the method may be provided for producing multi-layer plastic strapping bands with a tensile strength of at least 300 N/mm².

The method comprises first a provisioning of plastic materials. Here, a first plastic material 1 is provisioned, which first plastic material 1 consists of 70 wt % to 100 wt % thermoplastic, first polymer and 0 wt % to 30 wt % of another component or multiple other components. In particular, the first plastic material 1 consists of 70 wt % to 98 wt % thermoplastic, first polymer and 2 wt % to 30 wt % of another component or multiple other components. Independent of the amount of the other component or of the other components of the first plastic material 1, this or these other component(s) may be formed by fillers, additives, plasticizers or also by one or more other polymer(s) than the first polymer, for example.

For example, a plastic material with a content of foreign polymer, i.e. a different polymer than the first, thermoplastic polymer, may be provisioned as the first plastic material 1 here. For example, a content of foreign polymer may be from 2 wt % to 30 wt %. Here, the foreign polymer may absolutely comprise a layer-forming gas- or liquid-barrier plastic, and/or a copolymer. Yet, a plastic material with a content of inorganic fillers may also be provisioned as the first plastic material 1, for example with a content of inorganic fillers of 2 wt % to 30 wt %, in particular 5 wt % to 30 wt %. The inorganic filler may be formed by chalk, talc or a mixture thereof, for example. Independent thereof or in addition, a plastic material comprising solid particles with a particle size of up to 500 μm, in particular 150 μm to 500 μm, may be provisioned as the first plastic material 1. Accordingly, the first plastic material 1 may be filtered and/or may have been filtered by a filtering device with a mesh size of 500 μm as part of the melting, or as part of a melting operation performed upstream of the present method. Also a plastic material comprising colorants, such as printing inks, may be provisioned as the first plastic material 1, for example with a content of 2 wt % to 30 wt % of colorants, in particular printing inks. Preferably, a post-consumer-recycling (PCR) plastic material may be provisioned as the first plastic material 1. Also a plastic material comprising components that are non-melting at a melting and/or processing temperature as part of the melting of the first plastic material may be provisioned as the first plastic material 1.

As schematically represented in FIG. 1, the at least one first plastic material 1 is melted in a subsequent method step by means of an extrusion device 2 while forming a first plastic melt 3.

As shown on the basis of the exemplary embodiment shown in FIG. 1, also a second plastic material 4 is provisioned. This second plastic material 4 consists of 90 wt % to 100 wt % semi-crystalline, thermoplastic, second polymer and 0 wt % to 10 wt % of another component or multiple other components. Independent of the amount of the other component or of the other components of the second plastic material 4, this or these other component(s) may be formed by fillers, additives, plasticizers or also by one or more other polymer(s) than the semi-crystalline, second polymer, for example.

In contrast to the first plastic material 1, however, a plastic material that does not comprise any printing inks, layer-forming gas- or liquid-barrier plastics and additionally components that are non-melting at a melting and/or processing temperature as part of the melting of the second plastic material 4, such as metals, wood fillers, glass (fibers) or also polymers melting at a higher temperature than the melting and/or processing temperature, may be provisioned as the second plastic material 4. Furthermore, a plastic material comprising a maximum content of 10 wt %, preferably a maximum of 5 wt % of inorganic filler, such as chalk or talc, or also colorants for dyeing plastic materials, for example, such as master batch dyes, may be provisioned as the second plastic material 4. A plastic material comprising solid particles with a particle size of up to 150 μm may be provisioned as the second plastic material 4. Accordingly, the second plastic material 4 may be filtered and/or may have been filtered by a filtering device with a mesh size of 150 μm as part of the melting, or as part of a melting operation performed upstream of the present method.

As can be seen from FIG. 1, also this second plastic material 4 will be provisioned melted in the subsequent method step by means of another extrusion device 5 while forming a second plastic melt 6.

The first plastic material 1 is provisioned with a content of 50 wt % to 100 wt % of exclusively mechanically recycled plastic material. In addition to the exclusively mechanically recycled plastic material, the first plastic material 1 may also comprise up to 50 wt % non-recycled or chemically recycled plastic material. Preferably, the first plastic material 1 may be provisioned with a content of 80 wt % to 100 wt % of exclusively mechanically recycled plastic material and additionally up to 20 wt % non-recycled or chemically recycled plastic material. The thermoplastic, first polymer may be formed by polyethylene terephthalate, polypropylene, polyethylene, polyamide or polystyrene, for example. In particular, a plastic material that consists entirely of exclusively mechanically recycled plastic material may be provisioned as the first plastic material 1. A non-recycled or chemically recycled plastic material, or also a high-quality, mechanically recycled plastic material, in particular a mechanically recycled post-industrial-recycling plastic material, may be provisioned as the second plastic material 4.

In particular, a plastic material with a melt mass flow rate (MFR) according to ISO 1133 of 2 g/10 min to 35 g/10 min may be provisioned as the first plastic material 1, and a plastic material with a melt mass flow rate (MFR) according to ISO 1133 that is equal or greater in comparison to the first plastic material may be provisioned as the second plastic material 4.

Preferably, it may be provided, that plastic materials of the same type are provisioned as the first plastic material 1 and as the second plastic material 4. In particular, plastic materials in which a chemical molecular formula of the thermoplastic, first polymer corresponds to a chemical molecular formula of the semi-crystalline, thermoplastic, second polymer are provisioned as the first plastic material 1 and as the second plastic material 4. In particular, plastic materials in which both the thermoplastic, first polymer and the semi-crystalline, thermoplastic, second polymer are formed by polypropylene may be provisioned as the first plastic material 1 and as the second plastic material 4.

In particular, a plastic material with a content of 2 wt % to 30 wt % of fillers, for example, may be provisioned as the first plastic material 1. In particular, a plastic material with a content of 2 wt % to 30 wt % of coloring filler(s) may be provisioned as the first plastic material 1.

Subsequently to the melting of the two plastic materials 1, 4 and formation of the corresponding plastic melts 3, 6, there is a joining of these two plastic melts 3, 6, as illustrated in FIG. 1. Here, the procedure is such that the second plastic melt 6 is joined with a top side 10 and a bottom side 11 of the first plastic melt 3, so that the second plastic melt 6 covers completely the top side 10 and the bottom side 11 of the first plastic melt 3.

A joining of the first plastic melt 3 and of the second plastic melt 6 may generally be carried out by means of multiple methods that are generally known. For example, the two plastic melts 3, 6 may be joined by means of a so-called coextrusion box 12, also referred to as a feedblock, and, after the joining, dispensed via a film extrusion tool 13 with a wide slot die, as illustrated roughly schematically in FIG. 1. Alternatively to the exemplary embodiment outlined in FIG. 1, also different, generally known methods for joining the plastic melts 3, 6 are conceivable, of course, such as by means of a so-called coextrusion tool and/or multi-layer dies, the use of multiple extrusion tools with respectively one die, and so on.

As can also be seen from FIG. 1, a forming of a multi-layer film strand 7 follows subsequently to the joining of the plastic materials 1, 4 and/or plastic melts 3, 6. This is achieved by feeding the joined plastic melts 3, 6 to a forming device 9 in a material transport direction 8, so that the multi-layer film strand 7 is formed from both plastic materials 1, 4.

As shown in FIG. 1, this enables a multi-layer film strand 7 to be formed with a base strand layer 14 from the first plastic material 1 and surface strand layers 15 from the second plastic material 4, which surface strand layers 15 are connected to a top side 15 and to a bottom side 16 of this base strand layer 14. This multi-layer film strand 7 is formed such that it consists of 50 wt % to 95 wt % of the first plastic material 1 and 5 wt % to 50 wt % of the second plastic material 4. In particular, the multi-layer film strand 7 may be formed such that it consists of 55 wt % to 90 wt % of the first plastic material 1 and 10 wt % to 45 wt % of the second plastic material 4.

In the exemplary embodiment represented in FIG. 1, a triple-layer film strand 7 may be formed as shown with a base strand layer 14 from the first plastic material 1 and surface strand layers 17 from the second plastic material 4, which surface strand layers 17 are connected to a top side 15 and bottom side 16 of this base strand layer 14.

As further illustrated in FIG. 1, the forming of the multi-layer film strand 7 may be carried out by means of the forming device 9, which comprises rotatably-mounted rolls 18, 19, 20, 21. As generally known, the forming device 9 may therefore be formed by a rolling mill, also referred to as a calender and/or smoothing calender, as also shown in the exemplary embodiment represented in FIG. 1. Here, a film strand thickness 22 of the multi-layer film strand 7 may be adjusted in a targeted manner, for example by guiding the first plastic melt 3 and the second plastic melt 6 through a gap 23 between adjacent rolls 19, 20, as generally known. To this end, at least one of the adjacent rolls 19, 20 may be adjustable for modifying the film strand thickness 22. A thickness of the multi-layer film strand 7 after the forming and/or the film strand thickness 22 illustrated in FIG. 1 may be adjusted, for example to 0.6 mm to 3.8 mm, preferably 0.8 mm to 2.8 mm.

Furthermore, there is also a cooling down of the plastic materials 1, 4, for the subsequent method steps. The cooling down of the multi-layer film strand 7 to a desired target temperature for steps may be performed exclusively by means of the forming device 9 itself. To this end, the first plastic melt 3 and the second plastic melt 6 joined with the first plastic melt 3 may be cooled down, for example by means of at least one temperature-controllable roll 18, 21 and/or roll with a temperature-controllable roll surface of the forming device 9. For example, a cooling agent may be able to be applied to at least one roll 18, 21 of the forming device. Additionally and/or alternatively, however, also a separate cooling down of the plastic melts 3, 6 may be performed before the forming of the multi-layer film strand 7 and/or an additional, separate cooling down of the film strand 7 may be performed after forming the multi-layer film strand 7 by means of an additional cool-down device, such as a water bath, not represented in FIG. 1.

Furthermore, at least one surface 24 of the multi-layer film strand 7 may be structured by means of at least one structured roll surface 25 as part of the method step of the forming of the multi-layer film strand 7. For example, the at least one surface 24 of the multi-layer film strand 7 may be provided with a microstructure, in particular with a microstructure in the sense of a matting, which microstructure is not detectable by the naked eye. Alternatively, it may also be of advantage for specific applications, however, if the surfaces 24 of the multi-layer film strand 7 are designed so as to be very smooth, i.e. are even smoothed by means of at least one roll surface.

In the exemplary embodiment of the method outlined in FIG. 1 to FIG. 4, it may be provided that, after being formed and cooled down, the multi-layer film strand 7 is split into individual, undrawn band strands 26, as represented in FIG. 2. In FIG. 2, the same reference numbers are used for the same parts/elements as in the preceding FIG. 1. To avoid unnecessary repetitions, the detailed description in the preceding FIG. 1 should be noted and/or is referred to.

This splitting and/or cutting of the multi-layer film strand 7 may in particular be performed before the drawing shown in FIG. 3, so that, as shown here, there is a drawing of the multi-layer, undrawn band strands 26 to multi-layer, drawn band strands 33. As represented in FIG. 2, also the multi-layer film strand 7 may be split into multi-layer, undrawn band strands 26 along the material transport direction 8 by means of the splitting devices 29 after the forming and before the drawing. Alternatively to the exemplary embodiment represented in FIGS. 1 to 4, however, also an execution of the method in which the formed and cooled-down, multi-layer film strand 7 is first drawn, and that such a drawn film strand is split into individual, multi-layer, drawn band strands 33 only after the drawing may generally be provided.

If a splitting of the multi-layer film strand 7 is to be carried out before the drawing, the multi-layer film strand 7 may be cooled down, preferably to a temperature of 75° C. to 135° C., in particular 80° C. to 130° C., for an in this case subsequent method step of the splitting.

If the procedure is in accordance with the exemplary embodiment shown in the figures, a splitting and/or cutting of the multi-layer film strand 7, along the material transport direction 8, into multi-layer, undrawn band strands 26 with first band strand widths 27 and first band strand thicknesses 28 may be performed by means of splitting devices 29, as can be seen from FIG. 2. Quite generally and independent of whether a splitting is performed before or after the drawing, a splitting of the multi-layer film strand 7 may be carried out by means of splitting devices 29 configured as knife blades, circular blades that are non-rotatable or rotatable along or opposite the material transport direction, or also by means of splitting devices 29 configured as a laser or water beam, for example. Of course, the number of splitting devices 29 and/or band strands 26 is merely exemplary in the exemplary embodiment in accordance with FIG. 2, and the respective number of splitting devices 29 and/or band strands 26, 33 may be varied, of course. In addition to the splitting devices 29 represented in FIG. 2, other splitting and/or cutting devices may be provided also in the peripheries of the multi-layer film strand 7 and/or of the outer multi-layer band strands 26, 33 if required or desired in order to trim the edges of the outer band strands 26, 33 and/or design the edges of the outer band strands 26, 33 as evenly as possible.

If a splitting is carried out before the drawing, it may further be provided in the method that at least some of the splitting devices 29 are adjusted along a direction 30 extending parallel to the band strand widths 27 for adjusting the first band strand widths 27, as illustrated in FIG. 2 by the corresponding double arrows. This measure enables in particular the first band strand widths 27 to be varied and/or adjusted as required and/or desired. To this end, the splitting devices 29 may be adjustably mounted and/or held at holding bars 31 aligned parallel to the direction 30 of the band widths 27, for example, as schematically represented in FIG. 2. In particular, all existing splitting devices 29 may be adjusted along the direction 30 extending parallel to the band strand widths 27 for adjusting the first band strand widths 27. In addition, in the context of the adjusting along the direction 30 of the band strand widths 27, it may also be provided, however, that at least some of the splitting devices 29 are adjusted away from the multi-layer film strand 7 or the undrawn, multi-layer band strands 26.

As mentioned above, a drawing in the material transport direction 8 either of the multi-layer film strand 7 or of the multi-layer, undrawn band strands 26 is to be carried out in the method by means of a stretching device 32. In the exemplary embodiment represented in FIG. 3, subsequently to the method step of the splitting, a drawing to multi-layer, drawn band strands 33 with second band strand widths 34 and second band strand thicknesses 35 in the material transport direction 8 of the multi-layer, undrawn band strands 26 is carried out by means of a stretching device 32. Also in FIG. 3, the same reference numbers and/or component designations as in the preceding FIGS. 1 and 2 are used for the same parts again. To avoid unnecessary repetitions, the detailed description in the preceding FIGS. 1 and 2 should be noted and/or is referred to.

Alternatively to the exemplary embodiment illustrated in FIG. 3 in relation to FIG. 2, however, also a drawing of the entire multi-layer film strand instead of the multi-layer, undrawn band strands 26, as shown in FIG. 3, and only subsequently a splitting of an accordingly drawn, multi-layer film strand 7 directly into multi-layer, drawn band strands 33 would be possible, of course.

Independent of this, as generally known, the drawing and/or stretching device 32 may be formed by a so-called stretching unit, in which the multi-layer, undrawn band strands 26, or the multi-layer film strand 7 are elongated and/or drawn in a transport direction 8 by means of successively faster rotating stretching and/or stripping devices 36, 37. In the exemplary embodiment represented in FIG. 3, the multi-layer, undrawn band strands 26 may be elongated and/or drawn to the multi-layer, drawn band strands 33. This achieves the desired preferred orientation of the macromolecule chains of the plastic materials 1, 4. Depending on the plastic material(s) 1, 4 used, the multi-layer, undrawn band strands 26, or optionally the multi-layer film strand 7, can be drawn with drawing ratios of 1:4 to 1:20. Upstream of the stretching device 32, or optionally between stripping devices 36, 37 of the stretching device 32 and/or of the stretching unit, at least one temperature-control device may be arranged in addition in order to allow for a targeted control of the temperature of the plastic material 1 or of the plastic materials 1, 4 for the drawing operation, as generally known. Such temperature-control devices, such as water baths, cooling or heating air, or infrared radiators, are generally known from the prior art and are not represented in more detail in FIG. 3.

If the procedure is in accordance with the exemplary embodiment shown in FIG. 1 to FIG. 4, the drawing and/or the elongation of the undrawn, multi-layer band strands 26 is accompanied by a deforming, of course, in particular by a reduction of the cross section, so that the second band strand widths 34 and thicknesses 35 are smaller than the first band strand widths 27 and thicknesses 28, as can also be seen from FIG. 3. The drawing enables the second band strand thicknesses 35 to be adjusted, for example to a value of 0.15 mm to 1.8 mm, preferably of 0.2 mm to 1.4 mm. In the exemplary embodiment represented, the second band strand widths 34 can be adjusted, by the splitting and subsequent drawing, to a value of 3 mm to 40 mm, in particular 4 mm to 36 mm, wherein the second band strand widths 34 may be selected predominantly according to the respectively intended purpose of use for the plastic strapping bands. If the multi-layer film strand 7 is alternatively drawn as a whole and split into the multi-layer, drawn band strands 33 only afterwards, equivalent considerations still apply with respect to the second band strand widths 34 and second band strand thicknesses 35, of course.

If the multi-layer film strand 7 is split before the method step of the drawing, it may be provided in the method that, subsequently to the drawing, actual values of the second band strand widths 34 are detected by means of at least one sensor device 38 and the splitting devices 29 are adjusted along the direction 30 extending parallel to the band strand widths 34 with respect to respectively desired target values for the second band strand widths 34 for adjusting the first band strand widths 27 on the basis of these detected actual values, as can best be seen in a combination of FIG. 2 and FIG. 3. Here, the sensor device 38 may be formed by an optical sensor device, in particular by a camera.

As can also best be seen in a combination of FIG. 2 and FIG. 3, it may furthermore be provided in the exemplary embodiment that the detected actual values of the second band strand widths 34 are transmitted to a control device 39 by the sensor device 38 and the splitting devices 29 are adjusted along the direction 30 extending parallel to the band strand widths 27, 34 through automated control by the control device 39 for adjusting the first band strand widths 27. A connection, in terms of signal technology, between the sensor device 38, FIG. 3, and the splitting devices 29, FIG. 2, to the control device 39 is indicated in FIGS. 2 and 3, respectively, by the dashed lines.

Independent thereof, subsequently to the drawing of the multi-layer film strand 7 or of the multi-layer, undrawn band strands 26, actual values of the second band strand thicknesses 35 can be detected in the method by means of at least one sensor device 40 and a and/or the film strand thickness 22 of the multi-layer film strand 7 can be adjusted by means of the forming device 9 with respect to respectively desired target values for the second band strand thicknesses 35, as can best be seen in a combination of FIG. 1 with FIG. 3. Also the at least one sensor device 40 for determining the actual values of the second band strand thicknesses 35 may be formed by an optical sensor, in particular a camera, again. Here, basically the same sensor device 38 that is also used to determine the second band strand widths 34 can be used, or also a separate sensor device 40, of course, as illustrated in FIG. 3.

Also in the context of the detecting of the actual values of the second band strand thicknesses 35, it may be provided that these detected actual values of the second band strand thicknesses 35 are transmitted to a and/or the control device 39 by the sensor device 40 and the film strand thickness 22 is adjusted through automated control of the forming device 9 by means of the control device 39. Also the connections, in terms of signal technology, of the sensor device 40 and the forming device 9 to the control device 39 required to this end are indicated by dashed lines in FIG. 1 and FIG. 3.

FIG. 4 shows even more possible steps of the method following the drawing and splitting. Also in FIG. 4, the same reference numbers and/or component designations as in the preceding FIGS. 1 to 3 are used for the same parts again. To avoid unnecessary repetitions, the detailed description in the preceding FIGS. 1 to 3 should be noted and/or is referred to.

For example, it may be provided that the multi-layer, drawn band strands 33 and/or a or both of their surfaces are subjected to a surface treatment by means of one or multiple surface treatment device(s) 41. A corresponding surface treatment may comprise, for example, a coating of the surface(s), such as with a wax or another coating agent. Yet, a surface treatment may also comprise a radiation or plasma treatment of the surface(s) of the multi-layer, drawn band strands 33, for example.

Furthermore, a surface or both surfaces of the multi-layer, drawn band strands 33 may be embossed by means of an embossing device 42, for example. This may optionally be performed additionally to the structuring by means of the forming device 9 mentioned above.

Finally, the multi-layer, drawn band strands 33 may be custom packaged, as also illustrated in FIG. 4, for example wound up on the wind-up device 43 shown in FIG. 4, often also referred to as a winding machine, and thus prepared for a transport.

FIG. 5 finally shows an exemplary embodiment for a multi-layer plastic strapping band 44 roughly schematically in a sectional view. The plastic strapping band 44 represented in FIG. 5 may in particular be produced according to the and/or with the method described above. The multi-layer plastic strapping band 44 may be a strapping band as specified in (ÖNORM) EN 13394 and/or be configured in accordance with (ÖNORM) EN 13394. The multi-layer plastic strapping band 44 may have a tensile strength of at least 300 N/mm².

As can be seen from FIG. 5, the plastic strapping band 44 consists of a base layer 45 from a and/or the first plastic material 1 and respectively one surface layer 48 from a and/or the second plastic material 4 connected to a top side 46 and one surface layer 48 from a and/or the second plastic material 4 connected to a bottom side 47 of this base layer 45. In the exemplary embodiment represented, it may also be provided that the multi-layer plastic strapping band 44 is configured in three layers.

The first plastic material 1, of which the base layer 45 consists, is formed by 70 wt % to 100 wt % thermoplastic, first polymer and 0 wt % to 30 wt % of another component or multiple other components. The second plastic material, of which the surface layers consist, is formed by 90 wt % to 100 wt % semi-crystalline, thermoplastic, second polymer and 0 wt % to 10 wt % of another component or multiple other components.

The first plastic material 1 has a content of 50 wt % to 100 wt % of exclusively mechanically recycled plastic material. The multi-layer plastic strapping band 44 consists of 50 wt % to 95 wt % of the first plastic material 1 and of 5 wt % to 50 wt % of the second plastic material 4.

The first plastic material 1 may in particular be formed by a plastic material consisting of 70 wt % to 98 wt % thermoplastic, first polymer and 2 wt % to 30 wt % of another component or multiple other components. Independent of the amount of the other component or of the other components of the first plastic material 1, this or these other component(s) may be formed by fillers, additives, plasticizers or also by one or more other polymer(s) than the first polymer, for example.

Here, the first plastic material may comprise a content of foreign polymer, for example, i.e. a different polymer than the first, thermoplastic polymer. For example, a content of foreign polymer may be from 2 wt % to 30 wt %. Here, the foreign polymer may absolutely comprise a layer-forming gas- or liquid-barrier plastic, and/or a copolymer. Yet, the first plastic material 1 may also comprise a content of inorganic fillers, for example a content of inorganic fillers from 2 wt % to 30 wt %, in particular 5 wt % to 30 wt %. Here, the inorganic filler may be formed by chalk, talc or a mixture thereof, for example. Independent thereof or in addition, the first plastic material 1 may comprise solid particles with a particle size of up to 500 μm, in particular 150 μm to 500 μm. The first plastic material 1 may also comprise colorants, such as printing inks, for example in a content of 2 wt % to 30 wt %. Preferably, the first plastic material 1 may be a post-consumer-recycling (PCR) plastic material.

In addition to the exclusively mechanically recycled plastic material, the first plastic material 1 may also have up to 50 wt % non-recycled or chemically recycled plastic material. Preferably, the first plastic material 1 may consist of a content of 80 wt % to 100 wt % of exclusively mechanically recycled plastic material and additionally up to 20 wt % non-recycled or chemically recycled plastic material. Independent of the origin and/or preparation and as specified in the claims, the first plastic material 1 consists of 70 wt % to 100 wt % of the thermoplastic, first polymer and 0 wt % to 30 wt % of the other component or the multiple other components. The thermoplastic, first polymer may be formed by polyethylene terephthalate, polypropylene, polyethylene, polyamide or polystyrene, for example. In particular, the first plastic material may consist entirely of exclusively mechanically recycled plastic material.

The second plastic material 4 may be formed by a non-recycled or chemically recycled plastic material, or also a high-quality, mechanically recycled plastic material, in particular by a mechanically recycled post-industrial-recycling plastic material. It holds true also for the second plastic material 4 that, independent of the amount of the other component or of the other components of the second plastic material, this or these other component(s) may be formed by fillers, additives, plasticizers or also by one or more other polymer(s) than the second, semi-crystalline polymer, for example.

Unlike the first plastic material 1, the second plastic material 4 may comprise no printing inks, no layer-forming gas- or liquid-barrier plastic and also no high-melting-point or non-melting components, such as metals, wood fillers, glass (fibers) or also polymers melting at a high temperature. Furthermore, the second a plastic material 4 may comprise a maximum content of 10 wt %, preferably a maximum of 5 wt % of inorganic filler, such as chalk or talc, or also colorants for dyeing plastic materials, for example, such as master batch dyes. The second plastic material 4 may comprise solid particles with a particle size of up to 150 μm.

Preferably, the multi-layer plastic strapping band 44 may consist of 55 wt % to 90 wt % of the first plastic material 1 and 10 wt % to 45 wt % of the second plastic material 4.

A thickness of the multi-layer plastic strapping band 44 roughly schematically represented in FIG. 5 merely by way of example may be 0.15 mm to 1.8 mm, preferably 0.2 mm to 1.4 mm, for example. A width of the multi-layer plastic strapping band 44 may be 3 mm to 40 mm, in particular 4 mm to 36 mm. The surface layer(s) 48 may be surface treated and may have an embossment 49, for example, as can also be seen on the basis of the exemplary embodiment represented in FIG. 5.

Generally, the first, thermoplastic polymer and the second, semi-crystalline, thermoplastic polymer may respectively be formed by any polymers.

Yet, in this context, it may be preferably provided that the first plastic material 1 and the second plastic material 4 are formed by plastic materials of the same type. In particular, the first plastic material 1 and the second plastic material 4 may be formed by plastic materials in which a chemical molecular formula of the thermoplastic, first polymer corresponds to a chemical molecular formula of the semi-crystalline, thermoplastic, second polymer. In particular, the first plastic material 1 and the second plastic material 4 may be formed by plastic materials in which both the thermoplastic, first polymer and the semi-crystalline, thermoplastic, second polymer are formed by polypropylene. The first plastic material 1 may be formed by a plastic material with a content of 2 wt % to 30 wt % of filler(s). In particular, the first plastic material 1 may be formed by a plastic material with a content of 2 wt % to 30 wt % of coloring filler(s).

The exemplary embodiments show possible embodiment variants, wherein it should be noted in this respect that the invention is not restricted to these particular illustrated embodiment variants of it, but that rather also various combinations of the individual embodiment variants are possible and that this possibility of variation owing to the teaching for technical action provided by the present invention lies within the ability of the person skilled in the art in this technical field.

The scope of protection is determined by the claims. However, the description and the drawings are to be adduced for construing the claims. Individual features or feature combinations from the different exemplary embodiments shown and described may represent independent inventive solutions. The object underlying the independent inventive solutions may be gathered from the description.

Any and all specifications of value ranges in the description at issue are to be understood to comprise any and all sub-ranges of same, for example the specification 1 to 10 is to be understood to mean that any and all sub-ranges starting from the lower limit 1 and from the upper limit 10 are comprised therein, i.e. any and all sub-ranges start at a lower limit of 1 or larger and end at an upper limit of 10 or less, e.g. 1 to 1.7, or 3.2 to 8.1, or 5.5 to 10.

Finally, as a matter of form, it should be noted that for ease of understanding of the structure, elements are partially not depicted to scale and/or are enlarged and/or are reduced in size.

Table of reference numbers

| | |
|---|---|
| 1 | plastic material |
| 2 | extrusion device |
| 3 | plastic melt |
| 4 | plastic material |
| 5 | extrusion device |
| 6 | plastic melt |
| 7 | film strand |
| 8 | material transport direction |
| 9 | forming device |
| 10 | top side |
| 11 | bottom side |
| 12 | coextrusion box |
| 13 | film extrusion tool |
| 14 | base strand layer |
| 15 | top side |
| 16 | bottom side |
| 17 | surface strand layer |
| 18 | roll |
| 19 | roll |
| 20 | roll |
| 21 | roll |
| 22 | film strand thickness |
| 23 | gap |
| 24 | surface |
| 25 | roll surface |
| 26 | band strand |
| 27 | band strand width |
| 28 | band strand thickness |
| 29 | splitting device |
| 30 | direction |
| 31 | holding bars |
| 32 | stretching device |
| 33 | band strand |
| 34 | band strand width |
| 35 | band strand thickness |
| 36 | stripping device |
| 37 | stripping device |
| 38 | sensor device |
| 39 | control device |
| 40 | sensor device |
| 41 | surface treatment device |
| 42 | embossing device |
| 43 | wind-up device |
| 44 | plastic strapping band |
| 45 | base layer |
| 46 | top side |
| 47 | bottom side |
| 48 | surface layer |
| 49 | embossment |

1. A method for producing multi-layer plastic strapping bands (44), comprising,
providing a first plastic material (1) comprising 70 wt % to 100 wt % of a thermoplastic, first polymer and 0 wt % to 30 wt % of another component or multiple other components, and providing a second plastic material (4) comprising 90 wt % to 100 wt % of a semi-crystalline, thermoplastic, second polymer and 0 wt % to 10 wt % of another component or multiple other components,
melting the first plastic material (1) by means of using an extrusion device (2) while forming a first plastic melt (3) and melting the second plastic material (4) using another extrusion device (5) while forming a second plastic melt (6),
joining the first plastic melt (3) and the second plastic melt (6), such that the second plastic melt (6) covers completely a top side (10) and a bottom side (11) of the first plastic melt (3),
forming a multi-layer film strand (7) by feeding the first plastic melt (3) and the second plastic melt (6) to a forming device (9) in a material transport direction (8), and cooling down the first plastic material (1) and the second plastic material (4), so that a base strand layer (14) and surface strand layers (17) connected to a top side (15) and to a bottom side (16) of this base strand layer (14) are formed,
splitting the multi-layer film strand (7) into multi-layer band strands (26, 33) along the material transport direction (8) using splitting devices (29),
drawing the multi-layer film strand (7) or the multi-layer band strands (26) in the material transport direction (8) using a stretching device (32),
wherein
the first plastic material (1) is provided with a content of 50 wt % to 100 wt % exclusively mechanically recycled plastic material, and wherein the multi-layer film strand (7) is formed such that the multi-layer film strand (7) comprises 50 wt % to 95 wt % of the first plastic material (1) and 5 wt % to 50 wt % of the second plastic material (4).

2. The method according to claim 1, wherein a plastic material with a melt mass flow rate (MFR) according to ISO 1133 of 2 g/10 min to 35 g/10 min is provided as the first plastic material (1), and wherein a plastic material with a melt mass flow rate (MFR) according to ISO 1133 that is equal or greater in comparison to the first plastic material (1) is provided as the second plastic material (4).

3. The method according to claim 1, wherein plastic materials of the same type are provided as the first plastic material (1) and as the second plastic material (4).

4. The method according to claim 3, wherein plastic materials in which a chemical molecular formula of the thermoplastic, first polymer corresponds to a chemical molecular formula of the semi-crystalline, thermoplastic, second polymer are provided as the first plastic material (1) and as the second plastic material (4).

5. The method according to claim 4, wherein plastic materials in which both the thermoplastic, first polymer and the semi-crystalline, thermoplastic, second polymer are formed by polypropylene are provided as the first plastic material (1) and as the second plastic material (4).

6. The method according to claim 1, wherein a plastic material with a content of 2 wt % to 30 wt % of filler(s) is provided as the first plastic material (1).

7. The method according to claim 6, wherein a plastic material with a content of 2 wt % to 30 wt % of coloring filler(s) is provided as the first plastic material (1).

8. The method according to claim 1, wherein the multi-layer film strand (7) is split into multi-layer band strands (26) using the splitting devices (29) after the forming and before the drawing.

9. The method according to claim 8, wherein the multi-layer film strand (7) is cooled down to a temperature of 75° C. to 135° C. for the method step of the splitting.

10. A multi-layer plastic strapping band (44), comprising a base layer (45) from a first plastic material (1) and surface layers (48) from a second plastic material (4), wherein the surface layers (48) are connected to a top side (46) and a bottom side (47) of this base layer (45), wherein the first plastic material (1) is formed by 70 wt % to 100 wt % thermoplastic, first polymer and 0 wt % to 30 wt % of another component or multiple other components, and wherein the second plastic material (4) is formed by 90 wt % to 100 wt % semi-crystalline, thermoplastic, second polymer and 0 wt % to 10 wt % of another component or multiple other components,
wherein
the first plastic material (1) has a content of 50 wt % to 100 wt % of exclusively mechanically recycled plastic material,
wherein the multi-layer plastic strapping band comprises 50 wt % to 95 wt % of the first plastic material (1) and 5 wt % to 50 wt % of the second plastic material (4).

11. The multi-layer plastic strapping band (44) according to claim 10, wherein the first plastic material (1) and the second plastic material (4) are formed by plastic materials of the same type.

12. The multi-layer plastic strapping band (44) according to claim 11, wherein the first plastic material (1) and the second plastic material (4) are formed by plastic materials in which a chemical molecular formula of the thermoplastic, first polymer corresponds to a chemical molecular formula of the semi-crystalline, thermoplastic, second polymer.

13. The multi-layer plastic strapping band (44) according to claim 12, wherein the first plastic material (1) and the second plastic material (4) are formed by plastic materials in which both the thermoplastic, first polymer and the semi-crystalline, thermoplastic, second polymer are formed by polypropylene.

14. The multi-layer plastic strapping band (44) according to claim 10, wherein the first plastic material (1) is formed by a plastic material with a content of 2 wt % to 30 wt % of filler(s).

15. The multi-layer plastic strapping band (44) according to claim 10, wherein the first plastic material (1) is formed by a plastic material with a content of 2 wt % to 30 wt % of coloring filler(s).
